(19) United States
(12) Patent Application Publication
(10) Pub. No.: US 2008/0289234 A1
(43) Pub. Date: Nov. 27, 2008

(54) Image Retention System

(75) Inventors: Ray Henry Everson, Queensland (AU); Bradley James Wruck, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(73) Assignee: COLORSCREEN PRINT PTY LTD, Queensland (AU)

(21) Appl. No.: 10/594,722

(22) PCT Filed: Apr. 1, 2005
(86) PCT No.: PCT/AU2005/000476

§ 371 Date: Jul. 31, 2008

(30) Foreign Application Priority Data
Apr. 2, 2004 (AU) 2004901756

(51) Int. Cl. G09F 7/20

(52) U.S. Cl. 40/426

(57) ABSTRACT

An image retention system for an ice cave image system including an ice cave panel with a central clear portion and an image substrate, the image retention system including a plurality of retention portions spaced about the central clear portion, each retention portion having magnetic properties and an attachment portion to attach the retention portion relative to the central clear portion of the ice cave panel and a clamping member having magnetic properties, wherein each retention portion locates the image substrate relative to the central clear portion of the ice cave panel and the image substrate is clamped in position between the retention portion and the clamping member.

### FIELD OF THE INVENTION

The present invention relates to image retention systems and particularly image retention systems used in vending machines in what are known as an “ice cave” image systems.

### BACKGROUND ART

“Ice cave” image systems are a conventional system which find particular application in displaying images in vending machines. The present invention relates to problems encountered with the conventional methods of positioning, changing and retention of the replaceable images in the ice cave panels.

As seen in FIG. 1, an ice cave panel 10 is generally a clear polycarbonate panel with a colorful border image 11 printed on the inner surface and extending about the perimeter of the panel 10. The central area 12 of the panel is left clear so that a image substrate 13 with an image printed thereon can be fixed relative to the ice cave panel 10 and aligned with the clear central area 11 of the ice cave panel 10. The printed image is then illuminated from behind the image substrate 13.

The conventional system of positioning and retaining the exchangeable printed image substrates 13 uses molded acrylic retention clips 14. The placing and the size of the clips is crucial as they have to be located in the opaque section 11 of the ice cave panel 10 so that they are not seen from the front of the panel 10 when the panel and image substrate 13 is illuminated from behind.

The printed image substrate 13 is provided with a plurality of tab members 15 which extend from the edge of the printed image substrate 13.

A first end of each retention clip 14 is formed as a planar attachment portion 18 and is attached to the printed side (inside) of the ice cave panel 10, or a part of the machine housing (not shown) typically using a double sided adhesive tape 16. A second, opposed end of each retention clip 14 extends towards the clear central area 11 of the panel 10.

The second end of each retention clip 14 has a substantially V-shaped portion 17. The tab members 15 of the image substrate are located between the V-shaped portions 17 and the ice cave panel 10, and the V-shaped portions 17 act to clamp the tab members 15 into position. This locates and retains the image substrate 13 in position relative to the clear central area 11 of the ice cave panel 10.

There are multiple problems with the conventional system. The amount of clamping force is limited to the strength of the adhesion between the double sided adhesive tape. As the tape ages, the strength of the force typically weakens and this allows the image substrate to move out of position. This movement can result in an image which is not viewable or at worst, an image that has a crumpled or wavy appearance.

Another problem arises because the image substrates are changed quite regularly to change the image displayed in the vending machines. When the image substrate is exchanged, the technician fitting the replacement image must be extremely cautious as the clips are easily dislodged or broken.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to an image retention system, which may at least partially overcome at least one of the abovementioned disadvantages or provide the consumer with a useful or commercial choice.

In one form, the invention resides in an image retention system for an ice cave image system including an ice cave panel with a central clear portion and an image substrate, the image retention system including
i. a plurality of retention portions spaced about the central clear portion, each retention portion having magnetic properties and an attachment portion to attach the retention portion relative to the central clear portion of the ice cave panel and
ii. a clamping member having magnetic properties,
   wherein each retention portion locates to image substrate relative to the central clear portion of the ice cave panel and the image substrate is clamped in position between the retention portion and the clamping member.

As stated above, the image retention system is particularly adapted to be used with an ice cave image display system. According to a further form, the invention may reside in an ice cave image system including an ice cave panel with an outer opaque portion and a central clear portion, an exchangeable image printed substrate adapted to be retained adjacent the ice cave panel and an image retention system, the image retention system including a plurality of retention portions spaced about the central clear portion, each retention portion having magnetic properties, and an attachment portion to attach the retention portion relative to the central clear portion of the ice cave portion and a clamping member having magnetic properties, wherein each retention portion locates to image substrate relative to the central clear portion of the ice cave panel and the image substrate is clamped in position between the retention portion and the clamping member.

Ice cave image display systems find particular application in displaying images in vending machines. The image retention system of the present invention provides a positive location for the image substrate in relation to the ice cave panel as well as providing a secure location for extended periods and easy replacement of the image substrate when required.

The image retention system includes a plurality of retention portions spaced about the central clear portion of the ice cave panel. The retention portions may be mounted directly onto the ice cave panel or may be mounted separately from the ice cave panel. The mounting of the retention portions may be accomplished by attaching the retention portions to or relative to a housing in which the ice cave display is used.

Preferably, each retention portion has magnetic properties. In particular, each of the retention portions may be manufactured of a metal in order to provide the magnetic properties. Typically, the retention portion may be formed as an single-piece portion.

The retention portion may be as simple as a planar sheet member or a planar sheet of metal folded, pressed or otherwise formed to assume an L-shaped configuration having a base portion and an upstand locating portion. Typically the base portion may be substantially larger than the upstand portion. Alternatively, the base portion of the retention portion may have magnetic properties and the upstand portion may be magnetically neutral.

The retention portion may include a locating portion. The locating portion is typically the upstand portion of the L-shaped portion. The locating portion may provide a positive location for the image substrate by providing an abutment for an edge of the image substrate. Together, the locating portions of the respective retention portions may define an opening into which the image substrate is place during installation and exchange.

The locating portion of the retention portions may have any shape and size provided that it is adapted to abut at least one edge of the image substrate.

Each retention portion includes an attachment portion to attach the retention portion relative to the central clear portion of the ice cave portion. The attachment portion may be as simple as being the base portion or may be more advanced allowing the retention portion to be mounted separately to the ice cave panel in order not to be seen when the image to be displayed is illuminated from behind.

Typically, the attachment portion will be the base portion of the L-shaped retention portion or a portion of the retention member. The base portion may be manufactured of metal or similar and may be of a size calculated according to the number of the retention portions to be used and the shape or weight of the image substrate to be retained. The base portion may be provided with a fastening means such as an adhesive means in order to securely fasten the retention means relative to the ice cave panel. Typically, the adhesive means may be a double-sided adhesive tape and it may be used to attach the retention means directly to the back surface of the ice cave panel.

The image retention system may also include a clamping member having magnetic properties and preferably, a clamping member will be provided for each retention member. Together, the clamping member and the retention portion will be provided as a pair, between which an edge of an image substrate may be clamped. Typically, the image substrate may be provided with a plurality of tab extension members extending from an edge of the image substrate to be more easily clamped.

Preferably, the clamping member may be a magnet. Typically, a small but powerful magnet will be used such as those manufactured of neodymium or its alloys. The magnet may have any shape or configuration but typically, the magnet provided will have a substantially planar face which is as large as possible when compared to the base portion of the retention member as this may increase the amount of clamping force which can be applied to the image substrate.

The clamping member will typically be attached to the retention member to which it is paired in order that the clamping member not be lost when removed as a part of the image substrate replacement procedure. Usually, the clamping member may be attached using a flexible member such as string or cable to an opening which may be provided in the upstand portion of the retention portion.

The locating portion of each retention portion preferably locates the image substrate relative to the central clear portion of the ice cave panel and the image substrate is then clamped in position between the retention portion and the clamping member using the magnetic force between the metal part of the retention portion and the magnet. Using a plurality of retention portions and clamping portions allows the weight of the image substrate to be shared between the retention portions.

### BRIEF DESCRIPTION OF THE DRAWINGS

Various embodiments of the invention will be described with reference to the following drawings, in which:

FIG. 1 is a schematic perspective view of a conventional ice cave image display system.

FIG. 2 is a perspective view of the conventional image retention system used to position and retain an image substrate in an ice cave image display system.

FIG. 3 is a perspective view of a preferred embodiment of the present invention.

### DETAILED DESCRIPTION OF THE PREFERRED EMBODIMENT

According to a preferred embodiment of the present invention, an image retention system is provided.

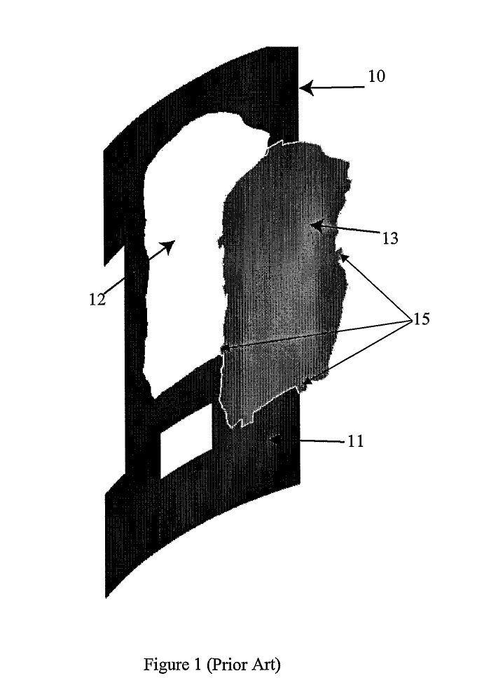

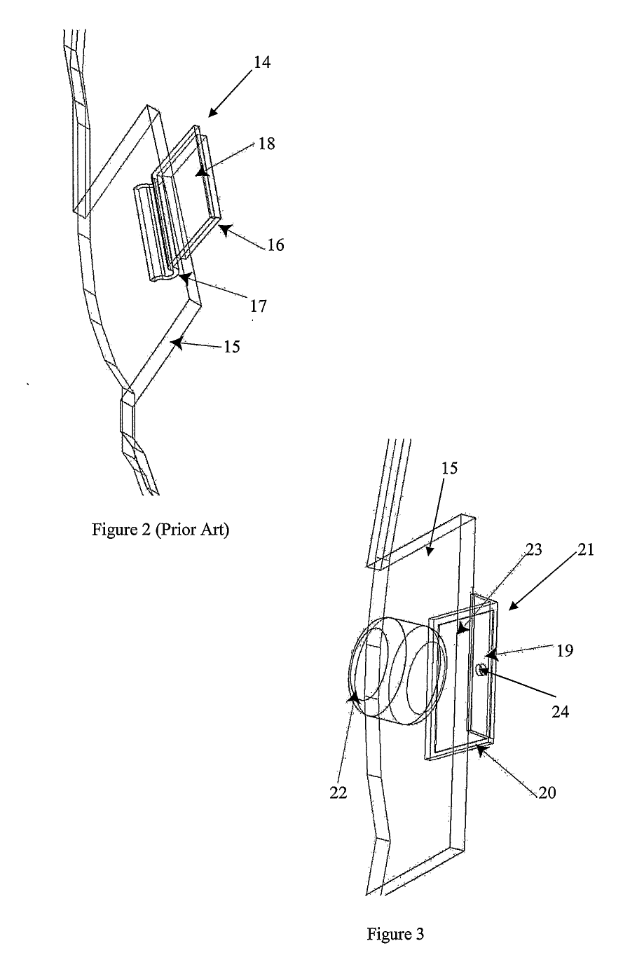

The image retention system according to the preferred embodiment illustrated in FIG. 3 will be used in an ice cave image system which includes an ice cave panel 10 with an outer opaque portion 11 and a central clear portion 12, and an exchangeable image printed substrate 13 adapted to be retained adjacent the ice cave panel 10 as illustrated generally in FIG. 1.

The image retention system includes a plurality of retention portions 21 spaced about the central clear portion 12 of the ice cave panel 10. Each retention portion 21 has magnetic properties, an upstand locating portion 19 and a base attachment portion 20 to attach the retention portion 21 relative to the central clear portion of the ice cave panel.

The image retention system also includes a magnetic clamping member 22. The upstand locating portion 19 of each retention portion 21 positively locates the image substrate 13 relative to the central clear portion 12 of the ice cave panel 11 and the image substrate 13 is clamped in position between the retention portion 21 and the magnetic clamping member 22.

The retention portions 21 are mounted directly onto the ice cave panel 10 but may be mounted separately from the ice cave panel.

Each retention portion 21 has magnetic properties. In particular, each of the retention portions 21 is manufactured of a metal in order to provide the magnetic properties. The retention portions 21 are formed of a planar sheet of metal in an L-shaped configuration having a base attachment portion 20 and an upstand locating portion 19. The base portion 20 is substantially larger than the upstand portion 19.

The locating portion 19 provides a positive location for the image substrate 13 by providing an abutment for the edge of the image substrate 13. Together, the locating portions 19 of the respective retention portions 21 define an opening (not shown) into which the image substrate 13 is placed during installation.

Each retention portion 21 includes an attachment portion 20 to attach the retention portion 21 relative to the central clear portion 12 of the ice cave panel 10.

The attachment portion is the base portion 20 of the L-shaped retention portion 21. The base portion 20 is provided with a fastening means such as a double-sided adhesive tape 23 in order to securely fasten the retention means 21 directly to the back surface of the ice cave panel 10.

The image retention system also includes a magnetic clamping member 22 and a magnetic clamping member 22 will be provided for each retention member 21. Together, the magnetic clamping member 22 and the retention portion 21 will be provided as a pair, between which an edge of an image substrate 13 is clamped. Typically, the image substrate 13 will be provided with a plurality of tab extension members 15 extending from an edge of the image substrate 13 to be more easily clamped.

Typically, each magnetic clamping member 22 is a small but powerful magnet such as those manufactured of neodymium or its alloys. The magnetic clamping member 22 may have any shape or configuration but typically, the magnetic clamping member 22 provided will have a substantially planar face which is as large as possible when compared to the base portion 20 of the retention member 21 as this increases the amount of clamping force which can be applied to the image substrate 13.

The magnetic clamping member 22 is attached to the retention member 21 to which it is paired in order that the magnetic clamping member 22 not be lost when removed as a part of the image substrate 13 replacement procedure. Usually, the magnetic clamping member 22 is attached using a flexible member such as string (not shown) to an opening 24 which is provided in the upstand locating portion 19 of the retention portion 21.

The locating portion 19 of each retention portion 21 locates the image substrate 13 relative to the central clear portion 12 of the ice cave panel 10 and the image substrate 13 is then clamped in position between the retention portion 21 and the magnetic clamping member 22 using the magnetic force between the metal part of the retention portion 21 and the magnetic clamping member 22. Using a plurality of retention portions 21 and magnetic clamping member 22 allows the weight of the image substrate 13 to be shared between the retention portions 21.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. An image retention system for an ice cave image system including an ice cave panel with a central clear portion and an image substrate, the image retention system including
i. a plurality of retention portions spaced about the central clear portion, each retention portion having magnetic properties and an attachment portion to attach the retention portion relative to the central clear portion of the ice cave panel and
ii. a clamping member having magnetic properties,
wherein each retention portion locates the image substrate relative to the central clear portion of the ice cave panel and the image substrate is clamped in position between the retention portion and the clamping member.

2. An ice cave image system including an ice cave panel with an outer opaque portion and a central clear portion, an exchangeable image printed substrate adapted to be retained adjacent the ice cave panel and an image retention system, the image retention system including a plurality of retention portions spaced about the central clear portion, each retention portion having magnetic properties, and an attachment portion to attach the retention portion relative to the central clear portion of the ice cave portion and a clamping member having magnetic properties, wherein each retention portion locates to image substrate relative to the central clear portion of the ice cave panel and the image substrate is clamped in position between the retention portion and the clamping member.

3. An image retention system according to claim 1 wherein the retention portions are mounted directly onto the ice cave panel.

4. An image retention system according to claim 1 wherein the retention portions are mounted to or relative to a housing in which the ice cave display is used.

5. An image retention system according to claim 1 wherein each of the retention portions is manufactured of a metal in order to provide the magnetic properties.

6. An image retention system according to claim 1 wherein the retention portions have an L-shaped configuration having a base attachment portion and an upstand locating portion.

7. An image retention system according to claim 6 wherein the base portion of the retention portion has magnetic properties and the upstand portion is magnetically neutral.

8. An image retention system according to claim 6 wherein the base portion is provided with a fastening means such as an adhesive means in order to securely fasten the retention means relative to the ice cave panel.

9. An image retention system according to claim 1 wherein a clamping member is provided for each retention member between which an edge of an image substrate is clamped, each clamping member being a magnet.

10. An image retention system according to claim 9 wherein the clamping member is attached to the retention member to which it is paired in order that the clamping member not be lost when removed as a part of the image substrate replacement procedure.
